(19) United States
(12) Patent Application Publication
(10) Pub. No.: US 2002/0194202 A1
(43) Pub. Date: Dec. 19, 2002

(54) Web enabled system and method for component hardware repair collaboration and material replacement

(76) Inventors: Gareth Jones, Cardiff (GB); Ross David Chilcott, Cardiff (GB); Chunilal Kerai, Cardiff (GB)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/883,026

(22) Filed: Jun. 15, 2001

(51) Int. Cl. G06F 7/00

(52) U.S. Cl. 707/200

(57) ABSTRACT

An internet-based system and method are provided for allowing component hardware repair and disposition collaboration by internal users and external users. A server is configured with a database of component service needs and component service solutions. The server is configured with a user interface allowing a user to input information into the database. This information, including component service capabilities and component service needs, is uploaded to the server. A user can then download information from the database including service capabilities of other users. A computer, having a connection to the server, allows the user to upload and download information.

### BACKGROUND OF THE INVENTION

The present invention relates to a database for tracking component hardware and repair needs.

Currently, many industries store component hardware in overhaul workshops, repair facilities, or other inventory areas. This hardware can be stored for prolonged periods of time, awaiting component repair investigation, evaluation and design. Each customer, overhaul site or repair facility has its own system for documenting the parts within their facilities. Some of these systems are detailed, listing most of the information required to determine if a repair is possible. Other systems are less detailed, and lack the information a repair engineer would need to determine if the design of a new repair is possible.

Due to the lack of a common system of documenting, communication, and storing component repair needs data, the opportunity to offer a focussed customer service on new repair may be missing. Some engineered solutions for repairing parts are visible only to the originator of the solution. Such improvements, however, may be of interest to multiple operations at various locations, to prevent re-invention of the solution.

It would be desirable to provide a database that holds listings of component repair solutions and details on component hardware and repair needs for which solutions are sought, that is accessible to multiple operation sites and/or various users.

### BRIEF SUMMARY OF THE INVENTION

A website, component repair solutions and needs database, and standardized reporting mechanism is proposed for tracking component serviceability and for collaborating on repair developments. The website can serve as a hub for collaborative efforts by multiple users from multiple locations. The database will house data for analysis to enable targeted customer service efforts.

Accordingly, the present invention provides a central website for housing standardized repair needs reports. The website further operates as a repository for the component repair capability listings of collaboration partners. Each collaborative partner will have a listing on the site, and the listing can be updated online as developments and approvals for new component repair solutions occur. When a user has an unserviceable component for which an approved solution is sought, a defect report can be accessed, typically online, to act as a catalyst for starting a chain of activities leading to the approved solution.

### BRIEF DESCRIPTION OF THE DRAWINGS

FIG. 1 is a schematic block diagram illustrating a website accessibility structure for the component repair tracking system; and

FIG. 2 is a schematic diagram of a web-enabled system to document, communicate and collaborate on hardware repair development requirements.

### DETAILED DESCRIPTION OF THE INVENTION

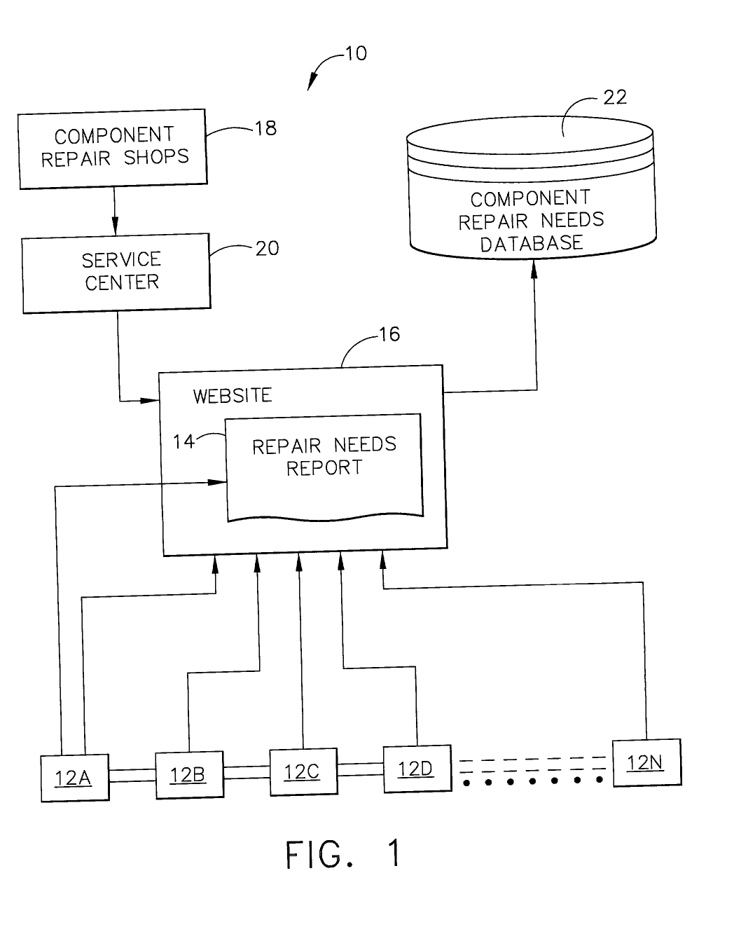

Referring to FIG. 1, there is a schematic block diagram 10 illustrating a database structure 10 for storing accessible details on component hardware and related repair needs for which solutions are sought. The system 10 comprises one or more collaboration partner listings 12A-12N that are representative of separate listings for each collaborator in the system. Each collaborative partner 12A-12N will have access only to its own listing. The listings can be updated online, as the collaborative partner develops and gains approval for new component repair solutions. The invention is described herein as a database for tracking component hardware and repair needs. It will be obvious to those skilled in the art, however, that the tracking concept of the present invention can be applied to a multitude of engineering or development type systems without departing from the scope of the invention.

Each collaborative partner also has the capability of transmitting repair needs data over a digital communication network and receiving information repair related to those needs. Each listing 12A-12N will contain information relating to component repairs for which previously engineered solutions have been formulated. Each collaborative partner will typically have access only to its own listing.

Continuing with FIG. 1, the structure of the system 10 allows for each collaborative partner 12A-12N to submit a repair needs report 14 to a server or central website 16. The server can be configured to store and download text and digital images. In a preferred embodiment, the central website 16 receives data not only from each collaborative partner 12A-12N, but also from other users of the application, such as component repair shops 18 (for example, through a main service center 20), and from a component repair needs database 22. The component repair needs database 22 can provide real time information on component repair needs of company brand components and alternative brand components requiring repair and/or replacement. The component repair needs database can also profile material requirements of widespread fleets incorporating the components to focus the repair development as well as to identify used serviceable material requirements.

Continuing with FIG. 1, communication with the central website 16 can comprise any kind of digital communication network or combination of digital communication networks. For example, the communication can be by means of a web browser, local area network (LAN), wide area network (WAN), World Wide Web, or any combination of these networks. Likewise, the user links 12A-12N can be of any form so long as the inputting of information, requests for information, and retrievable of information can be communicated between each link 12 and the central website 16. The communication between the component repair shops 18 and the service center 20 with the central website 16, and the component database 22 with the central website 16 can be implemented in the form of a web server.

The central website 16 provides each of the collaborative partners with an interface that permits the partner to convey requests for a recommended repair and receive the repair service recommendation. The interface includes an input portion and an output portion. The input portion of the interface is used to convey information from the collaborative partner to the central website 16. The output portion conveys information from the central website 16 to the collaborative partner, and is typically displayed on the monitor of the partner's computer. However, the output portion is capable of being displayed on other output peripherals, like printers. Typically, the input information is generated by the collaborative partner's actuation of an input peripheral, such as a mouse or a keyboard.

In the illustrated embodiment of FIG. 1, the interface is provided by web pages that can be transmitted by the central website 16 to each of the collaborative partners 12A-12N. A web page can include input and/or output portions. The input portion of a web page allows the collaborative partner to enter information relevant to repair needs, using an input peripheral, such as a mouse or keyboard. The output portion of a web page is used to provide the collaborative partner with an existing repair solution recommendation. In addition, the output portion of a web page can be used to solicit information relevant to the repair capabilities of the collaborative partner.

Although the configuration described herein refers to a website 16 being geographically and physically separated from each user link 12A-12N, this does not preclude integrating the website data and information from website 16 into each of the user sites 12A-12N to create a stand-alone system. In such a case, it is feasible to use a network to update the information from website 16 resident in each of the computers 12A-12N. It is also feasible to download the website 16 information and data to the user computer 12A-12N each time a repair solution is requested from the website 16.

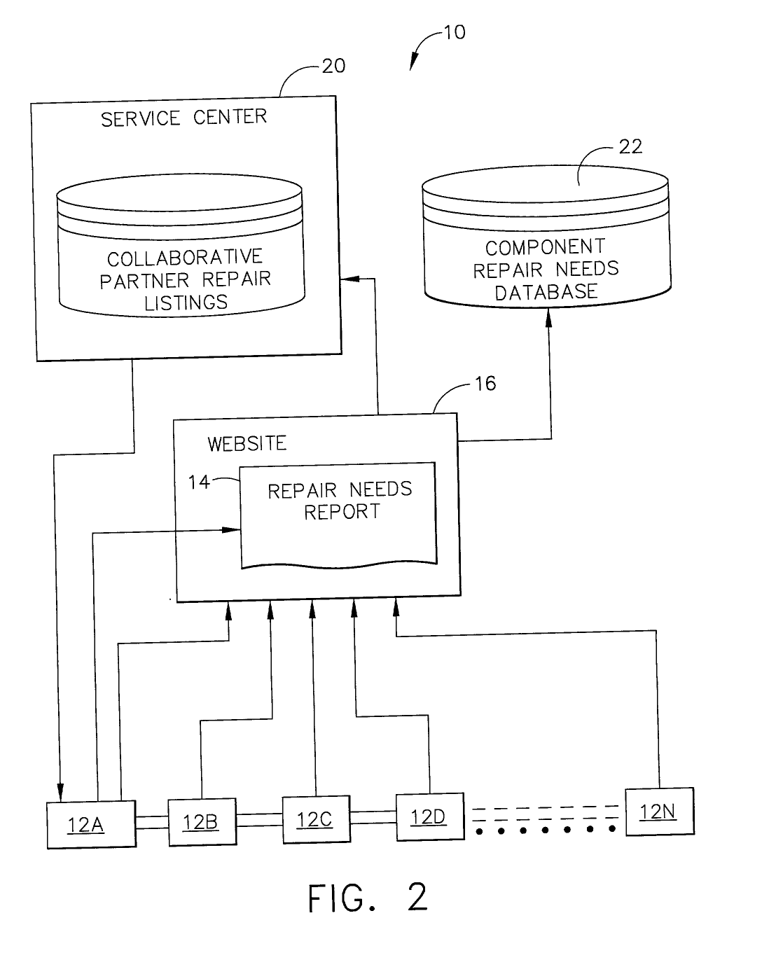

Continuing with FIG. 1 and referring also to FIG. 2, during communication between the website 16 and the user sites 12A-12N, all repair needs are deposited at the component database 22. This provides real time information on component repair needs for multiple brands of components in need of repair or replacement. The component database 22 also provides the ability to profile material requirements of world wide fleets by age of fleet, to enhance focus of repair development and to locate sources of used serviceable material. This replacement material intelligence provided by the component database 22 also provides opportunities to target material burn off, broker material, target engine teardown businesses, and create a hub for component repair development. Finally, the component database 22 can provide a link or information to locate replacement of components.

Communication between the website 16 and the user links 12A-12N also categorizes the repairs each user is capable of handling, and saves this collaborative partner repair listing data at the service center 20. The service center 20 can maintain a list of locally developed repair capabilities for each of the collaborative partners. The list can include repair developments in progress as well as repairs already solved. When a user provides information on its own repair solutions and repair development capabilities, the information is saved at the service center 20. When a user requests information on a needed repair, the information stored in the service center 20 is searched to find and provide any relevant available information previously supplied by other users.

Since component recovery is typically less expensive than component replacement, it is beneficial to all users to share their repair data. This prevents multiple users from having to develop the same repair solution, and can provide faster repair solution data. The business application developed herein allows users of name brand components to collaborate online with users of off brand components, to develop new component repairs. The website 16 can be used to offer repair services between users and to bring separate users together in any manufacturing or service industry. The separate users can collaborate remotely to repair parts and components, to increase knowledge, increase speed of repair, and decrease costs.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for storing service needs of users comprising:
a repository for collecting component service capability listings of the users;
an interface for allowing updating of the component service capability listings;
a database for storing the repository and receiving component service solution requests from the users; and
a link for responding to component service solution requests using the collected component repair capability listings.

2. A system as claimed in claim 1 wherein said user comprises multiple users.

3. A system as claimed in claim 2 wherein the database is owned by an owner entity.

4. A system as claimed in claim 3 wherein the multiple users comprise users internal to the owner entity and users external to the owner entity.

5. A system configured for component hardware repair and disposition collaboration by internal users and external users, said system comprising:
a server configured with a database of component service needs and component service solutions, said server further configured with a user interface allowing a user to input information into the database for upload to said server including component service capabilities and component service needs, and allowing a user to download information from the database including service capabilities of a first user to a second user;
at least one computer; and
an interface between the at least one computer and the server.

6. A system as claimed in claim 5 wherein the component service needs are reviewed for potential engineering opportunities.

7. A system as claimed in claim 5 wherein access to said server is configured to be secured by user password.

8. A system as claimed in claim 5 wherein said user comprises multiple users.

9. A system as claimed in claim 8 wherein the database is owned by an owner entity.

10. A system as claimed in claim 9 wherein the multiple users comprise users internal to the owner entity and users external to the owner entity.

11. A system as claimed in claim 5 wherein the interface is provided by web pages that can be transmitted from the database to the user.

12. A system as claimed in claim 5 wherein the component service needs comprise repair needs.

13. A system as claimed in claim 5 wherein said server is configured to store and download text and digital images.

14. A method for allowing collaboration on component hardware repair and disposition by internal users and external users using a system which includes a server and at least one client system, the method comprising the steps of:
uploading component service needs of the user to the server;
downloading from the server, web pages configured to direct internal and external users to a database within the server, the database configured with component service capability information;
uploading user selections input into the web pages to the server; and
downloading from the server component service capability information responsive to the component service needs.

15. A method as claimed in claim 14 further comprising the step of configuring the server to be secured by user password.

16. A method as claimed in claim 14 wherein the component service needs and component service capability information comprise component repair needs and component repair capability information.

17. A method as claimed in claim 14 further comprising the step of configuring the server to receive, categorize, and store user component service capabilities based on information provided by the internal and external users.

18. A method as claimed in claim 14 further comprising the step of configuring the server to receive, profile, track and store user component service needs.

19. A method as claimed in claim 14 further comprising the step of configuring the server to store and download text and digital images.
